(19) United States
(12) Patent Application Publication
(10) Pub. No.: US 2026/0184234 A1
(43) Pub. Date: Jul. 2, 2026

(54) A COMPUTER-IMPLEMENTED METHOD FOR CONTROLLING A COOLING SYSTEM OF A POWER ASSEMBLY

(71) Applicant: VOLVO TRUCK CORPORATION, Göteborg (SE)

(72) Inventors: Fredrik BLOMGREN, Kärra (SE); Pranav ARYA, Göteborg (SE)

(73) Assignee: VOLVO TRUCK CORPORATION, Göteborg (SE)

(21) Appl. No.: 19/131,696

(22) PCT Filed: Nov. 28, 2022
(86) PCT No.: PCT/EP2022/083518

§ 371 Date: May 21, 2025

(51) Int. Cl. B60L 58/33; B60L 50/75; B60L 58/40; H01M 8/04537; H01M 8/04701

(52) U.S. Cl. CPC B60L 58/33; B60L 50/75; B60L 58/40; H01M 8/04626; H01M 8/04723; B60L 2200/40; B60L 2240/547; B60L 2240/642; B60L 2240/66; B60L 2240/68; B60L 2240/80; B60L 2260/54

(57) ABSTRACT

A method for controls a cooling system of a power assembly having a fuel cell unit and an electric energy storage system. The cooling system is controllable to cool the fuel cell unit to a first temperature at which the fuel cell unit can generate power at a first power level, and at which the electric energy storage system delivers output power when the power request is above the first power level. The method comprises predicting a power request for power delivery from the power assembly during a future time interval, determining an electric energy level of the electric energy storage system, determining if the power assembly will be unable to deliver output power according to the power request throughout the time interval, controlling the cooling system to cool the fuel cell unit to a second temperature higher than the first temperature.

### TECHNICAL FIELD

The disclosure relates generally to cooling of fuel cell systems. In particular aspects, the disclosure relates to a computer-implemented method for controlling a cooling system of a power assembly comprising a fuel cell unit and an electric energy storage system. The disclosure can be applied in heavy-duty vehicles, such as trucks, buses, and construction equipment. The disclosure may further be applied in stationary applications, such as in generator sets and similar. Although the disclosure may be described with respect to a heavy-duty truck, the disclosure is not restricted to any particular vehicle.

### BACKGROUND

Electric batteries are becoming a more common source of power for providing propulsion for vehicles, also for heavy-duty vehicles such as buses and heavy-duty trucks. Such batteries are rechargeable and typically include a number of battery cells that may be connected in series or in parallel forming a complete battery pack for the vehicle. In addition to the battery packs, an electrified propulsion system comprises one or more electric machines operable to generate a propulsion torque on one or more wheels of the vehicle.

Battery powered electric propulsion provides many benefits, for example, reduced emission levels and more silent vehicles. However, heavy-duty vehicles require a large electric energy capacity of the batteries, feeding electric power to the electric machines to provide a desirable vehicle operating range. The electric energy capacity of the batteries is thus a limiting factor for heavy-duty vehicles.

By including a fuel cell in the electric propulsion system of the vehicle, the operational range of the vehicle may be extended. Electric power generated by the fuel cell can be fed to the battery, or directly to the electric machine(s) for powering of the vehicle. The fuel cell is sensitive to degradation arising at, e.g., start-up, shut-down, power ramp-up and -down, and elevated temperatures. It is therefore generally desirable to keep the fuel cell power constant and the temperature relatively low during operation. The battery is used for storing excess electric energy generated by the fuel cell when a power request for propulsion of the vehicle is below the fuel cell power, and the stored electric energy of the battery is used for propulsion when the power request exceeds the fuel cell power.

However, if the vehicle is faced with a long and difficult climb, it may happen that the battery gets depleted before reaching a top of the climb. The reason for this is that the power request during such a climb may exceed the fuel cell power over an extended time period, hence requiring the battery to constantly, or nearly constantly, deliver power without any opportunity for recharging. At the end of the climb, the power assembly may therefore be unable to deliver power in accordance with the power request, forcing the vehicle to travel at a reduced speed, such as at a crawling speed.

### SUMMARY

According to a first aspect of the disclosure, a computer-implemented method for controlling a cooling system of a power assembly according to claim 1 is provided. The power assembly comprises a fuel cell unit and an electric energy storage system. The power assembly is operable to deliver output power in accordance with a power request. The cooling system is controllable to a first operational mode in which it cools the fuel cell unit to a first temperature at which the fuel cell unit is controllable to generate power at a first power level, and in which the electric energy storage system is controlled to deliver output power at least when the power request is above the first power level. The method comprises:
predicting, by a processor device of a computer system, the power request for output power delivery from the power assembly during a future time interval,
determining, by the processor device, an electric energy level of the electric energy storage system,
determining, by the processor device, if a first condition is fulfilled, wherein the first condition is considered fulfilled when, based on the determined electric energy level, it is determined that the power assembly with the fuel cell unit generating power at the first power level will be unable to deliver output power in accordance with the power request throughout the future time interval,
in response to determining that the first condition is fulfilled, controlling, by the processor device, the cooling system to a second operational mode in which it cools the fuel cell unit to a second temperature being higher than the first temperature.

The first aspect of the disclosure may seek to reduce problems with battery depletion and reduced output power during extended periods of time with relatively high power requests from the power assembly, such as during long and difficult climbs for fuel cell powered vehicles. A technical benefit may include the possibility to temporarily increase the output power from the power assembly. This is achieved since, at the second temperature which is higher than the first temperature, the fuel cell unit can generate power at a second power level being higher than the first power level. Hence, with temporarily relaxed cooling constraints, the fuel cell unit can produce a larger amount of output power, whereby the power assembly is able to temporarily deliver an increased output power. Problems with battery depletion arising during extended time periods with high power requests may thereby be reduced.

Thus, according to the present disclosure, when it is determined that the electric energy level of the electric energy storage system, such as of a battery pack of a vehicle, is insufficient to be able to comply with the power request over the future time interval given that the fuel cell unit delivers power at the first power level, cooling constraints are relaxed by controlling the cooling system to the second operational mode.

The electric energy level of the electric energy storage system may be understood as a total amount of electric energy stored in the electric energy storage system. The electric energy level may e.g. be expressed in terms of a state-of-charge (SoC) value of the electric energy storage system, i.e., a percentage of a nominal rated energy capacity of the electric energy storage system.

The power request may be predicted as a sequence of instantaneous power requests at given time instants over the future time interval, and/or as one or more average or approximate values of the power request over the future time interval. In a vehicle, the power request may be predicted based on an approximated topography, i.e., road gradients, along a planned/expected travelling route, such as based on approximated or averaged road gradients along sub-intervals of the planned or expected travelling route.

It is to be noted that the future time interval may be defined in terms of distance, such as when the power assembly is provided in a vehicle travelling along a travelling route. In that case, the future time interval may be defined in terms of a distance interval along an expected travelling route. The distance interval and the time interval are mathematically connected through the vehicle speed exerted during the distance interval.

Optionally, the method further comprises, in response to determining that the first condition is not fulfilled, controlling the cooling system to the first operational mode. Operation at the lower first temperature is thereby continued as long as it is not found necessary to increase the output power from the fuel cell unit. Furthermore, the first operational mode is resumed as soon as the predicted power request decreases to a level at which it is no longer necessary to operate the fuel cell unit at the higher second power level.

Optionally, in the first operational mode, at least one coolant temperature setpoint of the cooling system is controlled to at least one first value, wherein controlling the cooling system to the second operational mode comprises controlling the at least one coolant temperature setpoint to at least one second value being higher than the at least one first value. The at least one coolant temperature setpoint may comprise a set of coolant temperature setpoints, in which case the at least one first and second values each comprises a set of first and second values, respectively, associated with the set of coolant temperature setpoints, each second value being higher than the corresponding first value.

Optionally, the at least one coolant temperature setpoint comprises an inlet coolant temperature setpoint for coolant delivered to a coolant inlet of the fuel cell unit, and an output coolant temperature setpoint for coolant received from a coolant outlet of the fuel cell unit. The inlet coolant setpoint used in the second operational mode should herein be higher than the inlet coolant setpoint used in the first operational mode, and the outlet coolant setpoint used in the second operational mode should be higher than the outlet coolant setpoint used in the first operational mode.

Optionally, the method further comprises communicating information relating to an operational mode of the cooling system to an energy management controller of the power assembly, the energy management controller being configured to control operation of the fuel cell unit in dependence on the communicated information. This allows the energy management controller to adapt the control of the fuel cell unit to the temperature and other cooling system parameters, e.g., coolant fluid pressure. The fuel cell unit may thereby be controlled to deliver a higher output power in the second operational mode than in the first operational mode.

Optionally, the power assembly is adapted to deliver output power contributing to the propulsion of a vehicle, and predicting the power request comprises:
receiving vehicle related information comprising at least one of traffic information for an expected travelling route of the vehicle during the future time interval, terrain information for the expected travelling route during the future time interval, topographic information for the expected travelling route during the future time interval, weather information for the expected travelling route during the future time interval, vehicle gross weight information, and
using said received vehicle related information for predicting the power request during the future time interval.
   One or more of the above vehicle related pieces of information may result in that the power request is predicted in an appropriate manner. An alternative or a complement to using a route planner, such as described above, may be to use machine learning/self-adapting algorithms.

Optionally, determining if the power assembly with the fuel cell unit generating power at the first power level will be unable to deliver output power in accordance with the power request throughout the future time interval comprises:
determining a first electric power capacity of the power assembly during the future time interval based on the determined electric energy level of the electric energy storage system and the first power level of the fuel cell unit,
determining that the predicted power request exceeds the first electric power capacity during at least a part of the future time interval.
   The electric power capacity is the amount of electric output power that the power assembly can deliver during the future time interval, including power produced by the fuel cell unit and power delivered from the electric energy storage system. The electric power capacity may vary during the future time interval. For example, the electric power capacity may decrease with decreasing SoC of the electric energy storage system. The actual time period that the cooling system is controlled to the second operational mode may be determined based on the time period or periods that the predicted power request exceeds the first power capacity. For example, it may be beneficial to start controlling the cooling system to the second operational mode before a point in time when the predicted power request exceeds the first power capacity.

In some examples, an expected total electric energy demand from the power assembly during the future time interval may be determined based on the predicted power request, such as by integrating the predicted power request over time. The expected total electric energy demand may be compared to a total amount of electric energy that the power assembly will be able to deliver during the future time interval, which can be determined based on the first power level and the electric energy level. If the total electric energy demand during the future time interval exceeds the total amount of electric energy deliverable with the fuel cell unit operated at the first power level, the cooling system may be controlled to the second operational mode.

Optionally, in the second operational mode of the cooling system, the fuel cell unit is controlled to generate power at a second power level higher than the first power level, and the electric energy storage system is controlled to deliver output power at least when the power request is above the second power level. The method may further comprise:
determining if a second condition is fulfilled, wherein the second condition is considered fulfilled when, based on the determined electric energy level, it is determined that the power assembly with the fuel cell unit generating power at the second power level will be unable to deliver output power in accordance with the power request throughout the future time interval,
in response to determining that the second condition is fulfilled, determining an adjusted output power request in accordance with which the power assembly will be able to deliver output power throughout the future time interval.
   This is useful for situations in which the power request is too high to comply with throughout the future time interval, even if the fuel cell unit produces power at the second power level. It makes is possible to better plan for situations in which this may arise. The adjusted output power request will herein be lower than the predicted power request.

Optionally, the method further comprises controlling the power assembly to deliver output power in accordance with the adjusted output power request during the future time interval. Preferably, the power assembly is controlled to deliver output power in accordance with the adjusted output power request throughout the future time interval to avoid depletion of the electric energy storage system, such as of the battery pack. For a vehicle, this may comprise reducing the vehicle speed throughout the time interval, e.g., throughout a difficult climb. Crawling speed at a top of the climb can thereby be avoided.

Optionally, the controlling of the cooling system to the second operational mode is initiated at a starting point of the future time interval. In this way, it is ensured that the fuel cell unit can deliver a higher output power throughout the time interval, thereby efficiently preventing battery depletion. The starting point may be set to occur prior to a point in time when the predicted power request is predicted to exceed the first power capacity.

Optionally, determining if the first condition is fulfilled further comprises determining a level of degradation of the fuel cell unit, wherein the first condition is considered fulfilled when the determined level of degradation is below a threshold level of degradation. In this way, relaxation of the cooling constraints, i.e., operation of the cooling system in the second operational mode, can be avoided when the fuel cell unit is aged, such as when a state-of-health (SoH) of the fuel cell unit is below a SoH threshold level and/or when the total time spent at an elevated temperature corresponding to the second operational mode of the cooling system is above a time threshold level. This is a way to avoid too rapid ageing of the fuel cell unit due to extended operation at a relatively high temperature.

Optionally, determining the level of degradation of the fuel cell unit comprises determining a total time that the cooling system has been operated in the second operational mode, and/or determining a state-of-health of the fuel cell unit. When the total time exceeds a time threshold level, the threshold level of degradation is in this case considered exceeded and the first condition is not fulfilled, i.e., operation of the cooling system in the second operational mode cannot be allowed. The total time is herein to be understood as the total time over a lifetime of the fuel cell unit.

According to a second aspect of the disclosure, a power assembly comprising a fuel cell unit, an electric energy storage system, and a cooling system is provided. The power assembly is operable to deliver output power in accordance with a power request. The cooling system is controllable to a first operational mode in which it cools the fuel cell unit to a first temperature at which the fuel cell unit is controllable to generate power at a first power level, and in which the electric energy storage system is controlled to deliver output power at least when the power request is above the first power level. The power assembly further comprises a processor device operable to control the cooling system, the processor device being configured to:
predict the power request for output power delivery from the power assembly during a future time interval,
determine an electric energy level of the electric energy storage system,
determine if a first condition is fulfilled, wherein the first condition is considered fulfilled when, based on the determined electric energy level, it is determined that the power assembly with the fuel cell unit generating power at the first power level will be unable to deliver output power in accordance with the power request throughout the future time interval,
in response to determining that the first condition is fulfilled, control the cooling system to a second operational mode in which it cools the fuel cell unit to a second temperature being higher than the first temperature.

The power assembly may further be operable to selectively charge and discharge the electric energy storage system in dependence on at least the power request and a fuel cell power generated by the fuel cell unit. When the fuel cell power exceeds the power request, electric energy is charged to the electric energy storage system, and when the fuel cell power is inferior to the power request, electric energy is discharged from the electric energy storage system.

Further advantages and features of the second aspect largely correspond to advantages and features described in connection with the first aspect. The processor device may hence be configured to carry out the method according to any example embodiment of the first aspect.

According to a third aspect of the disclosure, a vehicle comprising the power assembly according to the second aspect or the processor device configured to perform the method according to the first aspect is provided. The vehicle may preferably be a heavy-duty vehicle, such as a heavy-duty truck.

According to a fourth aspect of the disclosure, a computer program product comprising program code for performing, when executed by a processor device, the method according to the first aspect is provided.

According to a fifth aspect of the disclosure, a control system comprising one or more control units configured to perform the method according to the first aspect is provided.

According to a sixth aspect of the disclosure, a non-transitory computer-readable storage medium comprising instructions, which when executed by a processor device, cause the processor device to perform the method according to the first aspect is provided.

The above aspects, accompanying claims, and/or examples disclosed herein above and later below may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein. There are also disclosed herein control units, computer readable media, and computer program products associated with the above discussed technical benefits.

### BRIEF DESCRIPTION OF THE DRAWINGS

With reference to the appended drawings, below follows a more detailed description of aspects of the disclosure cited as examples.

FIG. 1 is a schematic view of a vehicle according to one example.

FIG. 2 is a schematic view of a cooling system according to one example.

FIG. 3 is a schematic diagram showing power and state-of-charge as a function of time for a power assembly according to one example.

FIG. 4 is a flow chart illustrating a method according to one example.

FIG. 5 is a schematic diagram of an exemplary computer system for implementing examples disclosed herein, according to one example.

The drawings are schematic and not drawn to scale.

### DETAILED DESCRIPTION

Aspects set forth below represent the necessary information to enable those skilled in the art to practice the disclosure.

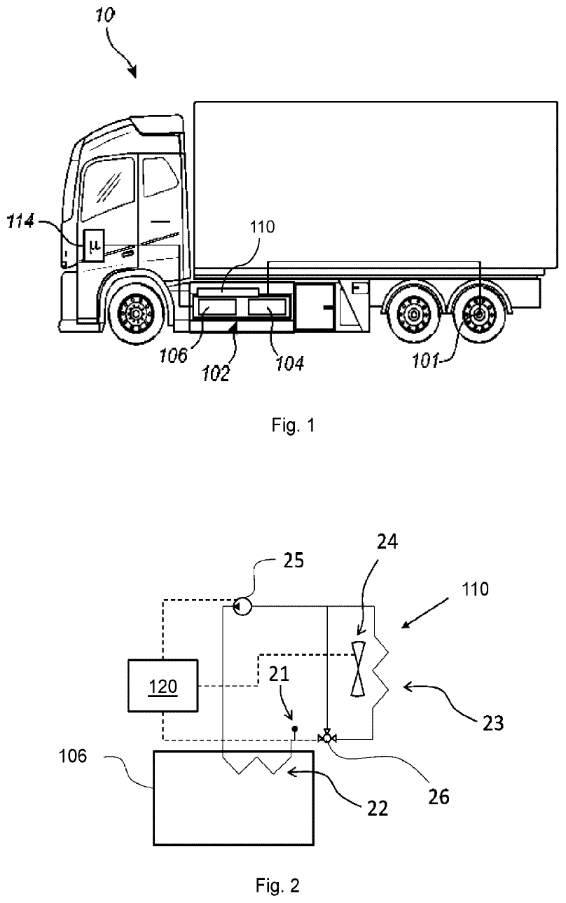

FIG. 1 illustrates a fuel cell powered electric vehicle (FCEV) 10 in the form of a heavy-duty truck. The FCEV 10 will in the following be referred to as a vehicle 10 and comprises one or more electric traction motors 101 for propelling wheels of the vehicle 10. The electric traction motor 101 is in the example embodiment arranged in the form of an electric machine.

The electric traction motor 101 is arranged to receive electric power from a power assembly 102 during propulsion, and to feed electric power generated by the electric machine 101 during braking to an electric energy storage system 104 of the power assembly 102. The electric energy storage system 104 is preferably a high voltage battery of the vehicle 10. As will be evident from the below disclosure, the power assembly 102 also comprises a fuel cell unit 106 electrically connected to the electric energy storage system 104. The fuel cell unit 106 comprises one or more fuel cells (not shown) configured to generate electric power by reacting hydrogen fuel with oxygen. The fuel cells may also be denoted as a fuel cell stack, wherein the fuel cell stack may comprise several hundreds of fuel cells.

The power assembly 102 further comprises a cooling system 110 configured to cool the fuel cell unit 106, which cooling system 110 is schematically illustrated in FIG. 2. The cooling system 110 may further be arranged to cool the electric energy storage system 104, although not illustrated in FIG. 2. The cooling system 110 may be configured to use a cooling fluid for cooling the one or more fuel cells during use. The cooling system 110 as illustrated in FIG. 2 comprises a heat exchanger 22, which is provided at the fuel cell unit 106 and is adapted to transfer heat from the one or more fuel cells to the cooling fluid. The cooling system 110 as shown further comprises an additional heat exchanger 23, or radiator, and a fan 24 for blowing air over the heat exchanger 23, thereby cooling the cooling fluid. The cooling system 110 further comprises a pump 25 for pumping the cooling fluid, in the shown embodiment in a counter clockwise direction. In addition, as shown, the cooling system 110 may comprise at least one valve 26, such as a bypass valve, arranged to bypass the cooling fluid with respect to the additional heat exchanger 23.

The cooling system 110 is operatively controlled by a control unit 120 comprising a processor device. The pump 25, the valve 26 and the fan 24 are controlled by the control unit 120 as indicated by the dashed lines in FIG. 2. The cooling system 110 is thereby controllable to cool the fuel cell unit 106 to a desired temperature. The control unit 120 may be configured to control the various components of the cooling system 110 by using one or more coolant temperature setpoints.

The cooling system 110 is by means of the control unit 120 controllable to a first operational mode in which it cools the fuel cell unit 106 to at least a first temperature at which the fuel cell unit 106 is controllable to generate power at a first power level P₁, and to a second operational mode in which it cools the fuel cell unit 106 to a second temperature. The second temperature is higher than the first temperature. The fuel cell unit 106 is thereby controllable to deliver power at a second power level P₂, higher than the first power level P₁, when the cooling system 110 is controlled to the second operational mode.

Optionally, and as shown in FIG. 2, a temperature sensor 21 is provided for measuring a temperature indicative of the temperature of the one or more fuel cells. In the shown embodiment, the temperature sensor 21 is located downstream the heat exchanger 22 and upstream the valve 26. It shall however be understood that a temperature sensor could additionally or alternatively be located somewhere else in the power assembly 102, as long it can measure a temperature which is indicative of the temperature of the one or more fuel cells. The temperature sensor 21 is configured to communicate temperature related data to the control unit 120.

As further illustrated in FIG. 1, the vehicle 10 may comprise a control unit 114 connected to the power assembly 102 for controlling operation thereof. The control unit 114 may include a microprocessor, microcontroller, programmable digital signal processor or another programmable device. The control unit 114 may also, or instead, include an application specific integrated circuit, a programmable gate array or programmable array logic, a programmable logic device, or a digital signal processor. Where the control unit 114 includes a programmable device such as the microprocessor, microcontroller or programmable digital signal processor mentioned above, the processor may further include computer executable code that controls operation of the programmable device. The control unit 114 of the vehicle may comprise, or be communicatively connected to, the control unit 120 of the cooling system 110. Hence, a single control unit may be provided for controlling operation of the cooling system 110 as well as of the fuel cell unit 106 and/or the electric energy storage system 104. Alternatively, two or more control unis may be provided, wherein the two or more control units may be communicatively connected to one another to share data and information.

The power assembly 102 is operable to deliver output power in accordance with a power request P, such as a power request received directly or indirectly from a driver or a control system of the vehicle 10. The power assembly 102 is further configured to selectively charge and discharge the electric energy storage system 104 in dependence on at least the power request P and an electric power generated by the fuel cell unit 106.

During propulsion of the vehicle 10, electric power is generated by the fuel cell unit 106, which electric power is fed to the electric energy storage system 104, thereby charging the electric energy storage system 104 with electric energy. The electric power generated by the fuel cell unit 106 may also be fed directly to the electric traction motor 101 during propulsion. Electric power may also be fed from the electric energy storage system 104 to the electric traction motor 101 during propulsion. When the cooling system 110 is controlled to the first operational mode and the fuel cell unit 106 generates power at the first power level P₁, the electric energy storage system 104 is controlled to deliver output power at least when the power request is above the first power level P₁. During steady-state operation, the fuel cell unit 106 is configured to generate electric power at a constant power level, regardless of the power request P.

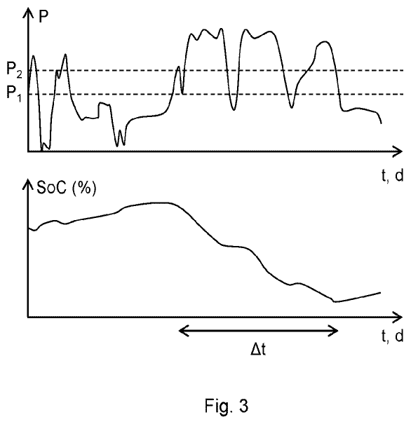

FIG. 3 schematically shows the power request P and the SoC of the electric energy storage system 104 as functions of time t and distance d during a long and difficult climb, such as in the Alps or in the Rocky Mountains. The power assembly 102 is configured to deliver output power in accordance with the power request P during the climb. The fuel cell unit 106 is controlled to generate and deliver power at the first power level P₁, being a constant power level. When the instantaneous power request P is lower than the first power level P₁, excess electric energy generated by the fuel cell unit 106, not needed for propulsion of the vehicle 10, is stored in the electric energy storage system 104. Additionally, or alternatively, excess electric energy generated by the fuel cell unit 106 may be dissipated as heat, such as by use of a resistor, when the electric energy storage system 104 can no longer store any additional energy. When the instantaneous power request P is higher than the first power level P₁, electric energy from the electric energy storage system 104 is instead consumed and used for propulsion of the vehicle 10. As can be seen from FIG. 3, the SoC of the electric energy storage system 104 increases as long as the power request P is below the first power level P₁. However, as soon as the power request P increases above the first power level P₁, the SoC of the electric energy storage system 104 starts to decrease. By integrating the power request P over time, it is found that the electric energy that needs to be discharged from the electric energy storage system 104 during the time interval Δt exceeds the amount of electric energy that can be charged into the electric energy storage system 104 during the climb. Hence, the electric energy storage system 104 is drained on electric energy during the climb. If the electric energy storage system 104 is depleted, there is a risk that the power assembly 102 cannot deliver power in accordance with the power request P during a final part of the climb.

By operating the fuel cell unit 106 to generate power at the second power level P₂, it is possible to charge more electric energy into the electric energy storage system 104 during the climb and depletion of the electric energy storage system 104 can be avoided. However, this requires a relaxation of cooling constraints, i.e., allowing the fuel cell unit 106 to be operated at a higher temperature.

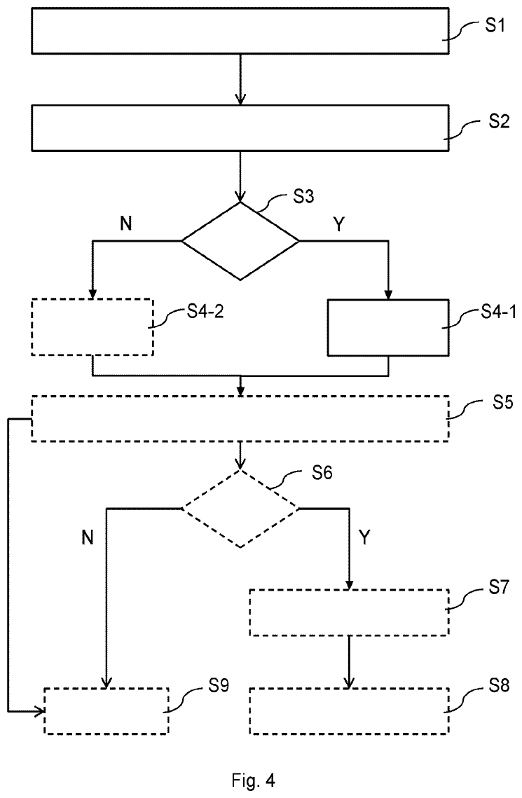

FIG. 4 illustrates a method for controlling the cooling system 110 according to an example of the present disclosure. The method enables the fuel cell unit 106 to generate output power at the second power level P₂. The method comprises actions listed below, which may be taken in any suitable order unless indicated otherwise. Optional actions are indicated with dashed boxes in FIG. 4.

In an action S1, the power request P for output power delivery from the power assembly 102 during a future time interval Δt is predicted by a processor device of a computer system, such as by a processor device comprised in the control unit 120 illustrated in FIG. 2. The power request may be predicted for a prediction horizon that comprises the future time interval Δt. The prediction horizon as well as the time interval may alternatively, or additionally, be expressed in terms of distance. The future time interval Δt may hence correspond to the entire prediction horizon, or be a time interval, or distance interval, within the prediction horizon, i.e., a sub-range of the prediction horizon. For example, the future time interval Δt may correspond to a road stretch comprising a difficult climb, expressed in terms of time or distance. The time interval Δt may correspond to a fixed distance interval, such as the road stretch comprising the difficult climb. The distance interval and the abovementioned time interval are mathematically connected through the vehicle speed exerted during this distance. Hence, for a fixed distance interval and with a target vehicle speed throughout the distance interval, the time interval Δt will have a known duration.

In an action S2, an electric energy level of the electric energy storage system 104 is determined by the processor device, such as by determining the SoC of the electric energy storage system 104.

In an action S3, the processor device determines if a first condition is fulfilled, wherein the first condition is considered fulfilled when, based on the determined electric energy level, it is determined that the power assembly 102 with the fuel cell unit 106 generating power at the first power level P₁ will be unable to deliver output power in accordance with the power request P throughout the future time interval Δt. To determine if the power assembly 102 with the fuel cell unit 106 generating power at the first power level P₁ will be unable to deliver output power in accordance with the power request throughout the future time interval Δt, the processor device may determine a first electric power capacity of the power assembly 102 during the future time interval Δt based on the determined electric energy level of the electric energy storage system 104 and the first power level P₁ of the fuel cell unit 106. The first electric power capacity is hence the power capacity of the power assembly 102 with the fuel cell unit 106 generating power at the first power level P₁. If the electric energy storage system 104 is depleted, the power capacity of the power assembly 102 is at most equal to the power capacity of the fuel cell unit 106. If the electric energy storage system 104 is fully charged, the power capacity of the power assembly 102 is higher than the power capacity of the fuel cell unit 106 since the electric energy storage system 104 is able to deliver output power in addition to the fuel cell unit 106.

After having determined the first electric power capacity, the processor device may proceed to determine that the predicted power request P exceeds the first electric power capacity during at least a part of the future time interval, such as during a major part of the future time interval or during the entire future time interval. If so, the first condition may be considered fulfilled.

The first condition may hence be considered fulfilled when the predicted power request P is larger than the sum of the first power level P₁ generatable by the fuel cell unit 106 and the determined electric energy level E_{ESS} of the electric energy storage system 104 per unit time t during the future time interval Δt.

In an action S4-1, carried out in response to determining that the first condition is fulfilled, the cooling system 110 is controlled by the processor device to a second operational mode, in which it cools the fuel cell unit 106 to the second temperature being higher than the first temperature. At the second temperature, the fuel cell unit 106 can produce a larger amount of output power, whereby the power assembly 102 is able to temporarily deliver an increased output power. The controlling of the cooling system 110 to the second operational mode may, by way of example, be initiated at a starting point of the future time interval Δt.

In response to determining that the first condition is not fulfilled in the action S3, the control unit 120 may in an action S4-2 control the cooling system to the first operational mode.

In the first operational mode of the cooling system 110, at least one coolant temperature setpoint of the cooling system 110 may be controlled to at least one first value. The action S4-1 of controlling the cooling system 110 to the second operational mode may in this case comprise controlling the at least one coolant temperature setpoint to at least one second value being higher than the at least one first value. The at least one coolant temperature setpoint may, by way of example, comprise at least two values, such as an inlet coolant temperature setpoint for coolant delivered to a coolant inlet of the fuel cell unit 106, and an output coolant temperature setpoint for coolant received from a coolant outlet of the fuel cell unit 106. Hence, the inlet and outlet coolant temperature setpoints may be controlled to a first set of values in the first operational mode, and to a second set of values in the second operational mode. Each one of the inlet and outlet coolant temperature setpoints is hereby controlled to a higher value in the second operational mode than the respective value in the first operational mode.

In an optional action S5, information relating to an operational mode of the cooling system 110 is communicated to an energy management controller of the power assembly 102. The energy management controller is configured to control operation of the fuel cell unit 106 in dependence on the communicated information. The energy management controller may, e.g., be comprised in the control unit 114 of the vehicle illustrated in FIG. 1 and/or in the control unit 120 illustrated in FIG. 2. The energy management controller may thereby control the fuel cell unit 106 to deliver a higher output power, at the second power level P₂, as it receives the information that the cooling system 110 is operated in the second operational mode.

When the power assembly 102 is adapted to deliver output power contributing to the propulsion of a vehicle 10, the action S1 of predicting the power request P may comprise:
receiving vehicle related information comprising at least one of traffic information for an expected travelling route of the vehicle 10 during the future time interval Δt, terrain information for the expected travelling route during the future time interval Δt, topographic information for the expected travelling route during the future time interval Δt, weather information for the expected travelling route during the future time interval Δt, vehicle gross weight information, and
using said received vehicle related information for predicting the power request P during the future time interval Δt.

Hence, a route planner may be used to predict the power request P. As an alternative or as a complement, self-adapting and/or learning algorithms may be used to predict the power request P. For instance, historical and/or statistical data relating to a power request collected during previous transport missions may be stored in a database on-board or off-board the vehicle. The previous transport missions may be transport missions carried out by the vehicle itself, and/or transport missions carried out by one or more other vehicles, such as by vehicles I a vehicle fleet. The previous transport missions may be transport missions along the same travelling route. A machine learning algorithm can be formulated to extract the necessary information from such a data base.

In the second operational mode of the cooling system 110, the fuel cell unit 106 may be controlled to generate power at the second power level P₂ higher than the first power level as mentioned above, whereby the electric energy storage system 104 is controlled to deliver output power at least when the power request P is above the second power level P₂. In an action S6, the processor device may determine if a second condition is fulfilled, wherein the second condition is considered fulfilled when, based on the determined electric energy level, it is determined that the power assembly 102 with the fuel cell unit 106 generating power at the second power level P₂ will be unable to deliver output power in accordance with the power request P throughout the future time interval Δt.

In response to determining that the second condition is fulfilled, an action S7 of determining an adjusted output power request in accordance with which the power assembly 102 will be able to deliver output power throughout the future time interval Δt may be carried out. An action S8 of controlling the power assembly 102 to deliver output power in accordance with the adjusted output power request during the future time interval Δt may follow. The fuel cell unit 106 may in connection with this be controlled to deliver power at the second power level P₂.

In response to determining that the second condition is not fulfilled, the power assembly 102 may instead in an action S9 be controlled to deliver output power in accordance with the “original” power request P. The fuel cell unit 106 may in connection with this be controlled to deliver power at the second power level P₂. The action S9 may in other examples follow directly on the action S5 of communicating information relating to an operational mode of the cooling system 110 to the energy management controller of the power assembly 102, i.e., without determining if the second condition is fulfilled or not.

In some examples, the action S3 of determining if the first condition is fulfilled may further comprise determining a level of degradation of the fuel cell unit 106, such as a state-of-health (SoH) and/or a time spent at an elevated temperature higher than the first temperature, such as at the second temperature. The first condition may thereby be considered fulfilled when the determined level of degradation is below a threshold level of degradation. Determining the level of degradation may comprise determining a total time that the cooling system 110 has been operated in the second operational mode, and/or determining a state-of-health of the fuel cell unit 106. When the degradation is larger than the threshold level, operation of the cooling system 110 in the second operational mode is not allowed, in order not to damage the fuel cell unit 106. The threshold level of degradation may be set such that an acceptable compromise between performance and lifetime is achieved.

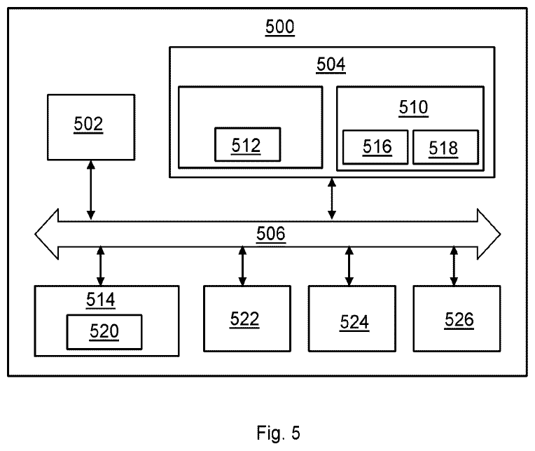

FIG. 5 is a schematic diagram of a computer system 500 for implementing examples disclosed herein, such as in the control unit 114 illustrated in FIG. 1 and/or in the control unit 120 illustrated in FIG. 2. The computer system 500 is adapted to execute instructions from a computer-readable medium to perform these and/or any of the functions or processing described herein. The computer system 500 may be connected (e.g., networked) to other machines in a LAN, an intranet, an extranet, or the Internet. While only a single device is illustrated, the computer system 500 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, etc., includes reference to one or more such devices to individually or jointly execute a set (or multiple sets) of instructions to perform any one or more of the methodologies discussed herein. For example, the control system may include a single control unit, or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 500 may comprise at least one computing device or electronic device capable of including firmware, hardware, and/or executing software instructions to implement the functionality described herein. The computer system 500 may include a processor device 502 (may also be referred to as a control unit), a memory 504, and a system bus 506. The computer system 500 may include at least one computing device having the processor device 502. The system bus 506 provides an interface for system components including, but not limited to, the memory 504 and the processor device 502. The processor device 502 may include any number of hardware components for conducting data or signal processing or for executing computer code stored in memory 504. The processor device 502 (e.g., control unit) may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processor device may further include computer executable code that controls operation of the programmable device.

The system bus 506 may be any of several types of bus structures that may further interconnect to a memory bus (with or without a memory controller), a peripheral bus, and/or a local bus using any of a variety of bus architectures. The memory 504 may be one or more devices for storing data and/or computer code for completing or facilitating methods described herein. The memory 504 may include database components, object code components, script components, or other types of information structure for supporting the various activities herein. Any distributed or local memory device may be utilized with the systems and methods of this description. The memory 504 may be communicably connected to the processor device 502 (e.g., via a circuit or any other wired, wireless, or network connection) and may include computer code for executing one or more processes described herein. The memory 504 may include non-volatile memory 508 (e.g., read-only memory (ROM), erasable programmable read-only memory (EPROM), electrically erasable programmable read-only memory (EEPROM), etc.), and volatile memory 510 (e.g., random-access memory (RAM)), or any other medium which can be used to carry or store desired program code in the form of machine-executable instructions or data structures and which can be accessed by a computer or other machine with a processor device 502. A basic input/output system (BIOS) 512 may be stored in the non-volatile memory 508 and can include the basic routines that help to transfer information between elements within the computer system 500.

The computer system 500 may further include or be coupled to a non-transitory computer-readable storage medium such as the storage device 514, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 514 and other drives associated with computer-readable media and computer-usable media may provide non-volatile storage of data, data structures, computer-executable instructions, and the like.

A number of modules can be implemented as software and/or hard-coded in circuitry to implement the functionality described herein in whole or in part. The modules may be stored in the storage device 514 and/or in the volatile memory 510, which may include an operating system 516 and/or one or more program modules 518. All or a portion of the examples disclosed herein may be implemented as a computer program product 520 stored on a transitory or non-transitory computer-usable or computer-readable storage medium (e.g., single medium or multiple media), such as the storage device 514, which includes complex programming instructions (e.g., complex computer-readable program code) to cause the processor device 502 to carry out the steps described herein. Thus, the computer-readable program code can comprise software instructions for implementing the functionality of the examples described herein when executed by the processor device 502. The processor device 502 may serve as a controller or control system for the computer system 500 that is to implement the functionality described herein, such as in the control unit 114 illustrated in FIG. 1 and/or in the control unit 120 illustrated in FIG. 2.

The computer system 500 also may include an input device interface 522 (e.g., input device interface and/or output device interface). The input device interface 522 may be configured to receive input and selections to be communicated to the computer system 500 when executing instructions, such as from a keyboard, mouse, touch-sensitive surface, etc. Such input devices may be connected to the processor device 502 through the input device interface 522 coupled to the system bus 506 but can be connected through other interfaces such as a parallel port, an Institute of Electrical and Electronic Engineers (IEEE) 1394 serial port, a Universal Serial Bus (USB) port, an IR interface, and the like. The computer system 500 may include an output device interface 524 configured to forward output, such as to a display, a video display unit (e.g., a liquid crystal display (LCD) or a cathode ray tube (CRT)). The computer system 500 may also include a communications interface 526 suitable for communicating with a network as appropriate or desired.

The operational steps described in any of the exemplary aspects herein are described to provide examples and discussion. The steps may be performed by hardware components, may be embodied in machine-executable instructions to cause a processor to perform the steps, or may be performed by a combination of hardware and software. Although a specific order of method steps may be shown or described, the order of the steps may differ. In addition, two or more steps may be performed concurrently or with partial concurrence.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the inventive concepts being set forth in the following claims.

1. A computer-implemented method for controlling a cooling system of a power assembly, the power assembly comprising a fuel cell unit and an electric energy storage system, the power assembly being operable to deliver output power in accordance with a power request, the cooling system being controllable to a first operational mode in which it cools the fuel cell unit to a first temperature at which the fuel cell unit is controllable to generate power at a first power level, and in which the electric energy storage system is controlled to deliver output power at least when the power request is above the first power level, the method comprising:
predicting, by a processor device of a computer system, the power request for output power delivery from the power assembly during a future time interval,
determining, by the processor device, an electric energy level of the electric energy storage system,
determining, by the processor device, if a first condition is fulfilled, wherein the first condition is considered fulfilled when, based on the determined electric energy level, it is determined that the power assembly with the fuel cell unit generating power at the first power level will be unable to deliver output power in accordance with the power request throughout the future time interval,
in response to determining that the first condition is fulfilled, controlling, by the processor device, the cooling system to a second operational mode in which it cools the fuel cell unit to a second temperature being higher than the first temperature.

2. The method according to claim 1, further comprising:
in response to determining that the first condition is not fulfilled, controlling the cooling system to the first operational mode.

3. The method according to claim 1, wherein, in the first operational mode, at least one coolant temperature setpoint of the cooling system is controlled to at least one first value, and wherein controlling the cooling system to the second operational mode comprises controlling the at least one coolant temperature setpoint to at least one second value being higher than the at least one first value.

4. The method according to claim 3, wherein the at least one coolant temperature setpoint comprises an inlet coolant temperature setpoint for coolant delivered to a coolant inlet of the fuel cell unit, and an output coolant temperature setpoint for coolant received from a coolant outlet of the fuel cell unit.

5. The method according to claim 1, further comprising:
communicating information relating to an operational mode of the cooling system to an energy management controller of the power assembly, the energy management controller being configured to control operation of the fuel cell unit in dependence on the communicated information.

6. The method according to claim 1, wherein the power assembly is adapted to deliver output power contributing to the propulsion of a vehicle, and wherein predicting the power request comprises:
receiving vehicle related information comprising at least one of traffic information for an expected travelling route of the vehicle during the future time interval, terrain information for the expected travelling route during the future time interval, topographic information for the expected travelling route during the future time interval, weather information for the expected travelling route during the future time interval, vehicle gross weight information, and
using said received vehicle related information for predicting the power request during the future time interval.

7. The method according to claim 1, wherein determining if the power assembly with the fuel cell unit generating power at the first power level will be unable to deliver output power in accordance with the power request throughout the future time interval comprises:
determining a first electric power capacity of the power assembly during the future time interval based on the determined electric energy level of the electric energy storage system and the first power level of the fuel cell unit,
determining that the predicted power request exceeds the first electric power capacity during at least a part of the future time interval.

8. The method according to claim 1, wherein, in the second operational mode of the cooling system, the fuel cell unit is controlled to generate power at a second power level higher than the first power level, and the electric energy storage system is controlled to deliver output power at least when the power request is above the second power level, the method further comprising:
determining if a second condition is fulfilled, wherein the second condition is considered fulfilled when, based on the determined electric energy level, it is determined that the power assembly with the fuel cell unit generating power at the second power level will be unable to deliver output power in accordance with the power request throughout the future time interval,
in response to determining that the second condition is fulfilled, determining an adjusted output power request in accordance with which the power assembly will be able to deliver output power throughout the future time interval.

9. The method according to claim 8, further comprising:
controlling the power assembly to deliver output power in accordance with the adjusted output power request during the future time interval.

10. The method according to claim 1, wherein the controlling of the cooling system to the second operational mode is initiated at a starting point of the future time interval.

11. The method according to claim 1, wherein determining if the first condition is fulfilled further comprises:
determining a level of degradation of the fuel cell unit,
wherein the first condition is considered fulfilled when the determined level of degradation is below a threshold level of degradation.

12. The method according to claim 11, wherein determining the level of degradation of the fuel cell unit comprises determining a total time that the cooling system has been operated in the second operational mode, and/or determining a state-of-health of the fuel cell unit.

13. A power assembly comprising a fuel cell unit, an electric energy storage system, and a cooling system, the power assembly being operable to deliver output power in accordance with a power request, the cooling system being controllable to a first operational mode in which it cools the fuel cell unit to a first temperature at which the fuel cell unit is controllable to generate power at a first power level, and in which the electric energy storage system is controlled to deliver output power at least when the power request is above the first power level, the power assembly further comprising a processor device operable to control the cooling system, the processor device being configured to:
predict the power request for output power delivery from the power assembly during a future time interval,
determine an electric energy level of the electric energy storage system,
determine if a first condition is fulfilled, wherein the first condition is considered fulfilled when, based on the determined electric energy level, it is determined that the power assembly with the fuel cell unit generating power at the first power level will be unable to deliver output power in accordance with the power request throughout the future time interval,
in response to determining that the first condition is fulfilled, control the cooling system to a second operational mode in which it cools the fuel cell unit to a second temperature being higher than the first temperature.

14. A vehicle comprising the power assembly according to claim 13.

15. A non-transitory computer program product comprising program code for performing, when executed by a processor device, the method according to claim 1.

16. A control system comprising one or more control units configured to perform the method according to claim 1.

17. A non-transitory computer-readable storage medium comprising instructions, which when executed by a processor device, cause the processor device to perform the method according to claim 1.
